(19) United States
(12) Patent Application Publication
(10) Pub. No.: US 2012/0175374 A1
(43) Pub. Date: Jul. 12, 2012

(54) Cookware with Handles having Embedded indicia

(75) Inventor: Stanley Kin Sui Cheng, Hillsborough, CA (US)

(73) Assignee: Meyer Intellectual Properties Ltd., Kowloon (HK)

(21) Appl. No.: 13/337,686

(22) Filed: Dec. 27, 2011

Related U.S. Application Data
(60) Provisional application No. 61/431,315, filed on Jan. 10, 2011.

(51) Int. Cl. A47J 27/00; B23P 19/04; B65D 25/28

(52) U.S. Cl. 220/573.1; 220/752; 29/428

(57) ABSTRACT

A cookware article has a handle that has an externally visible embedded medallion with a contrasting appearance to the bulk of the handle. The handle is preferably stainless steel while contrasting medallion is preferably cooper, and may be embedded in the a cavity formed in the handle by an impact bonding process that spreads it laterally to bind with the cavity wall, as well as imprint a trademark or other indicia in to it. The medallion can be used to indicate that the cookware vessel itself has a cooper core to distinguish it from the similar cookware without such external indicia on the handle.

### CROSS REFERENCE TO RELATED APPLICATIONS

The present application claims the benefit of priority to the U.S. provisional patent application of the same title having application Ser. No. 61/431,315, which was filed on Jan. 10, 2011, which is incorporated herein by reference.

### BACKGROUND OF INVENTION

The present invention relates to cookware, and in particular with cookware articles such as vessel and lids for vessel, using handles that have indicia related to the cookware composition, and method of forming such handles.

High performance cookware is frequently constructed of multiple layers of material to achieve a desired combination of thermal performance, clean ability and aesthetics. In particular clad cookware might have aluminum or cooper core for fast heating, and a stainless steel interior. Copper cookware is especially appreciated where there is a need to heat and cool the food quickly, such as when preparing delicate sauces or candy making, due to the higher thermal conductivity and low thermal mass of copper.

Many chefs and home cooks have different types of cookware of similar external appearance, but different internal construction for different purposes. Accordingly, it can be difficult for a cook to quickly select the correct pan to use, even if copper cookware has some externally visible copper at the rim. It should be appreciated that the internal surfaces of cooper cookware are always coated with some material to avoid food contact with copper to prevent leaching into food. The only exception is specialized cookware, such as for candy making, where the sugar syrup is believed to be largely un-reactive with copper.

Accordingly, it would be desirable to provide a means to identify certain attributes of cookware that are unique to the largely non-visual internal construction.

It is therefore a first object of the present invention to provide a means for a user or consumer to distinguish cookware having a different internal construction from that with substantially the same external appearance by looking at the handle.

It is another object to further provide a simple means to permanently display a trademark on a handle.

### SUMMARY OF INVENTION

In the present invention, the first object is achieved by providing an article of cookware comprising: a vessel having a bottom portion and substantially upright sides surrounding and connected to bottom portion, the uprights sides terminating at a rim, at least one handle connected to the upright sides of the vessel, wherein said handle is formed of a first material to give a general external appearance, and has at least one medallion embedded in the a portion thereof to provide a contrasting appearance to the first material.

Another object is achieved by providing such an article of cookware as above wherein the first material is a metal having a silver appearance and the embedded medallion a metal selected from group consisting of brass, bronze, copper and alloys thereof to provide the contrasting appearance.

Another object is achieved by providing such an article of cookware as above wherein the medallion is an annular ring of embedded material.

Another object is achieved by providing such an article of cookware as above wherein the medallion is wrapped around an extending portion of the handle.

Another object is achieved by providing such an article of cookware as above wherein the medallion is generally planar and embedded in a generally planar portion of the handle.

Another object is achieved by providing such an article of cookware as above wherein the vessel has a clad construction being formed of multiple layers and the medallion has generally the same external appearance as one of the multiple layers.

Another object is achieved by providing such an article of cookware as above wherein the vessel has a clad construction being formed of multiple layers and the medallion has generally the same external appearance of a layer that is primarily covered by the other multiple layers.

Another object is achieved by providing a handle for an article of cookware comprising a flange portion for connection to an article of cookware and a graspable portion attached to the flange portion wherein said handle is formed of a first material to give a general external appearance, and has at least one medallion embedded in one of the grip and flange portion thereof to provide a contrasting appearance to the first material.

Another object is achieved by a process for making a cookware handle, the process comprising the steps providing a handle having a smooth body with a cavity, providing a medallion, inserting the medallion in the cavity, and impacting the medallion wherein the medallion compresses, expands and is locked into the cavity.

Another object is achieved by the above process for making a cookware handle wherein the cavity has a non-circular edge.

Another object is achieved by the above process for making a cookware handle wherein the cavity has scalloped edge.

Another object is achieved by the above process for making a cookware handle wherein the cavity has a different shape than the medallion prior to said step of impacting.

Another object is achieved by the above process for making a cookware handle wherein the medallion is a metal selected from group consisting of brass, bronze, copper and alloys.

Another object is achieved by the above process for making a cookware handle wherein the medallion has a contrasting external appearance than an adjacent portion of the handle.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A plan view of an embodiment of the cookware article and handles

FIG. 1B is an exterior elevation of the cookware article and handles of FIG. 1A, with a partial cut away portion showing the internal construction of the cookware vessel at a bottom portion via a cross-sectional elevation

FIG. 2A plan view of an alternative embodiment of the handles

FIG. 2B is an exterior elevation of alternative embodiment of the handles

FIG. 3A is a cross-sectional elevation of a step in the process of forming the cookware handle for the embodiments of FIGS. 1AB and 2A/B.

FIG. 3B is a cross-sectional elevation the completed cookware handle formed in the step shown in FIG. 3A.

FIG. 3C is a cross-sectional elevation of an alternative embodiment of the completed cookware handle formed in the step shown in FIG. 3A.

FIG. 4A is a plan view of a step in the process of forming the cookware handle for another embodiments of the invention.

FIG. 4B is a cross-sectional elevation of portion of the completed cookware handle formed in the step shown in FIG. 4A.

FIG. 5A is a front perspective view of another embodiment of the invention showing a handle having a coin like generally flat medallion and annular ring medallions, whereas FIG. 5B is a rear elevation view of the embodiment in FIG. 5A.

FIG. 6A-C illustrate alternative embodiments of a method of affixing the annular ring medallions shown in FIGS. 5A and 5B, FIGS. 6A and 6B being cross-sectional elevations of different process embodiment showing the handle and taken along the primary axis of symmetry, whereas FIG. 6C is another cross-sectional elevation that is transverse thereof taken at section line C-C in FIG. 6B.

### DETAILED DESCRIPTION

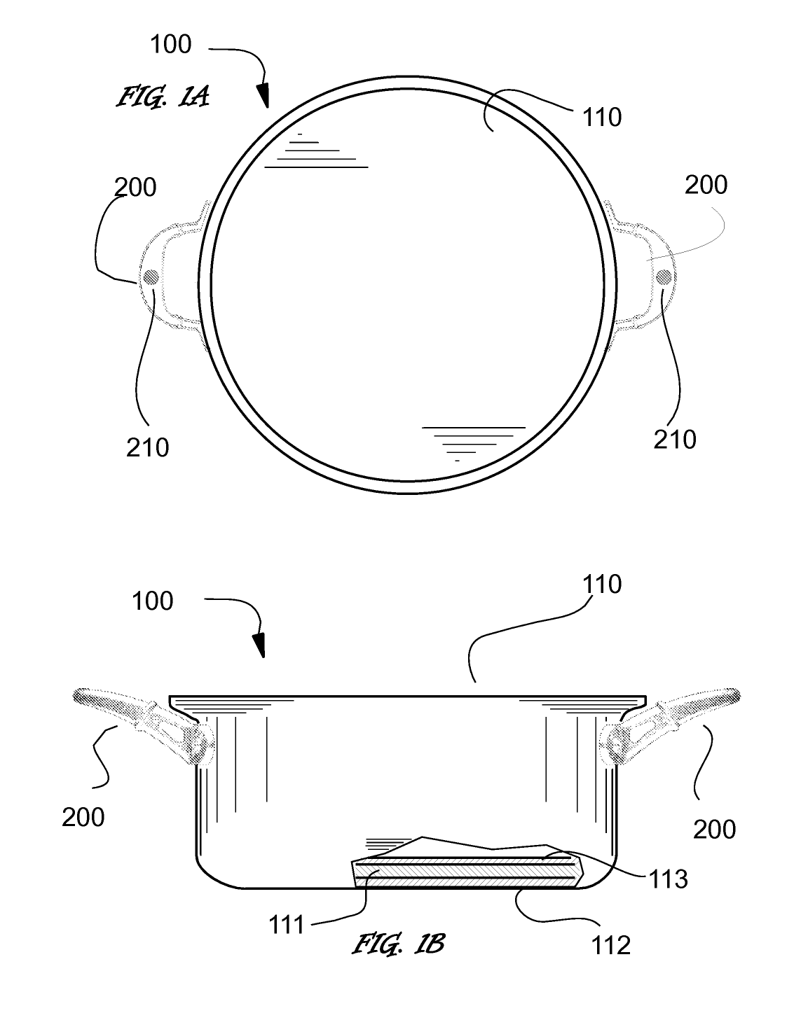

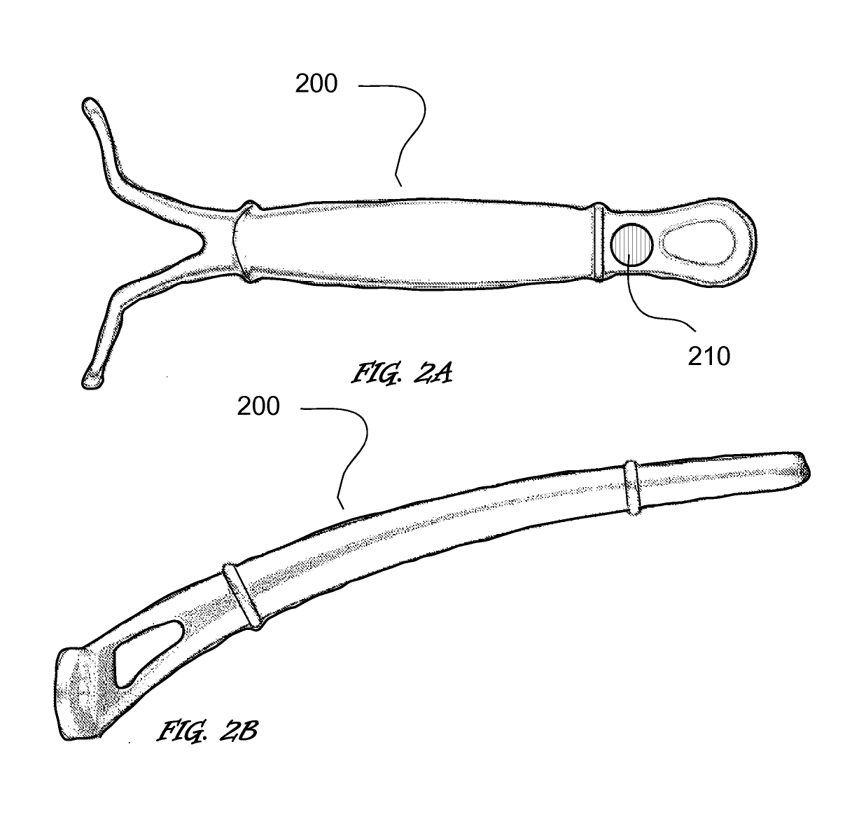

Referring to FIGS. 1 through 6, wherein like reference numerals refer to like components in the various views, there is illustrated therein a new and improved Cookware with Handles having Embedded Indicia, generally denominated 100 herein.

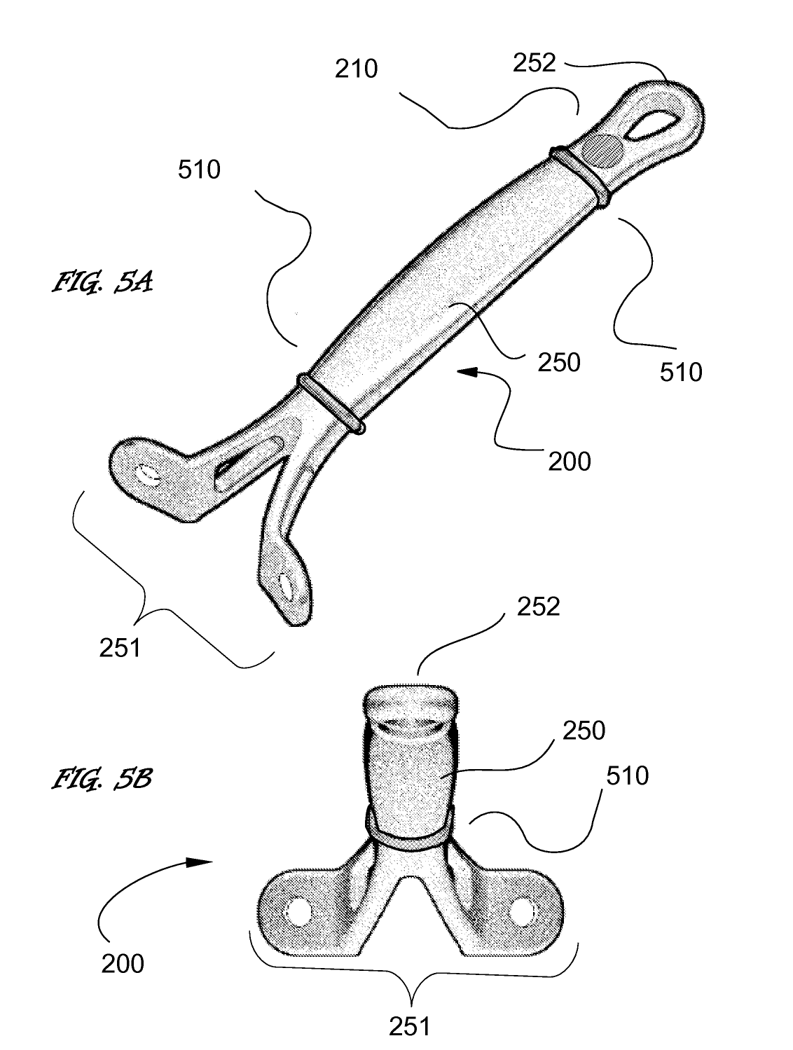

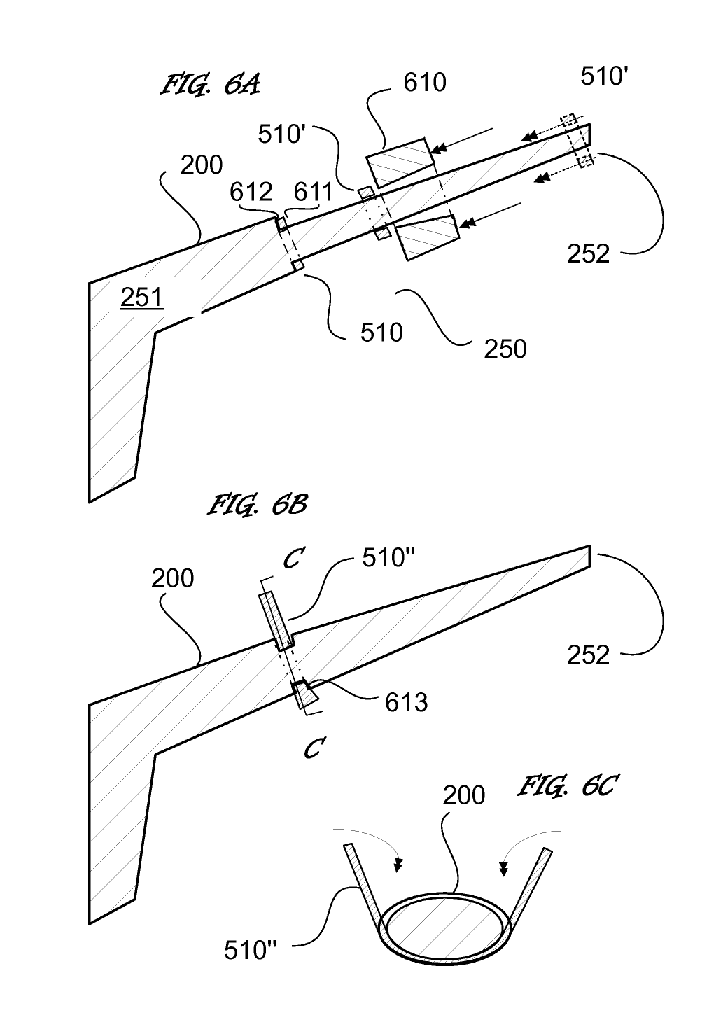

In accordance with the present invention, the inventive cookware article, which can be either a vessel or lid for a vessel, 100 has a handle body 200 extending outward (from a fluid containing vessel 110) or upward from a lid for such a vessel. The handle 200 has an embedded indicia or medallion 210 in an upward facing portion thereof, as shown on FIGS. 1A, 2A and 4B. It is generally, but not necessarily intended that such a handle 200 is metal and the medallion 210 is metal, so that the handle 200 and medallion 210 have a contrasting appearance. However, such a handle may also have non metallic portion such as a rubber grip portion. Medallion 210 is preferably a planar member inserted in a generally planar portion of the handle, but can also be curved to match the curve of the handle. The medallion can be a monolithic member, or an annular member, such as a ring. A ring like member can be inserted into a planar surface on the handle, a curved surface, or around a portion of a handle as illustrated in the embodiments of FIGS. 5 and 6. Such a ring like medallion can be a continuous annulus, or discontinuous as in a ring formed from a section of wire.

As shown in FIG. 1A, in the most preferred embodiments, the vessel 110 has at least of a wall and or bottom constructed of laminated layers or plies in which one layer 111 is copper or an alloy thereof, and the medallion 210 on the handle 200 is copper or copper colored, to indicate that the cookware article has such a cooper layer in the multilayer construction, as this construction may not be visible from the external appearance of the pan, or if visible may not be a prominent feature. The externally visible layers or plies, such as the outer wall 112 or the inner wall and bottom 113 would normally be stainless or steel or aluminum.

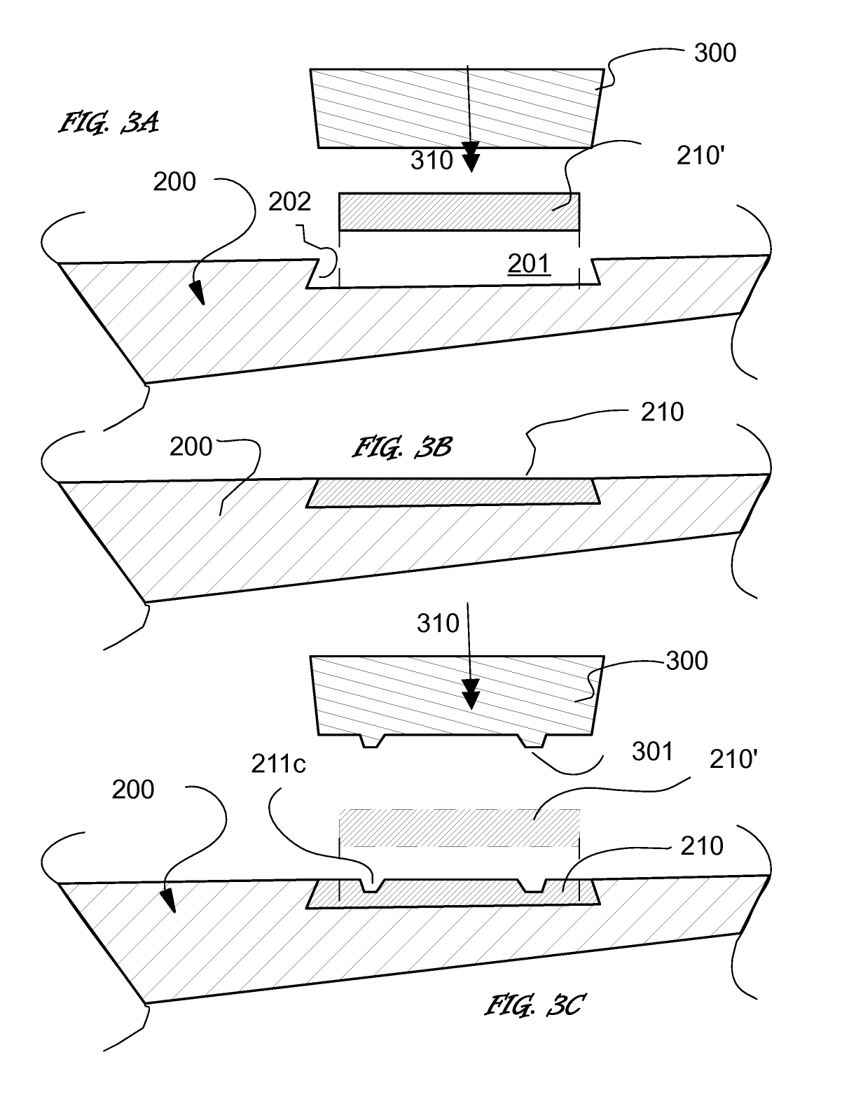

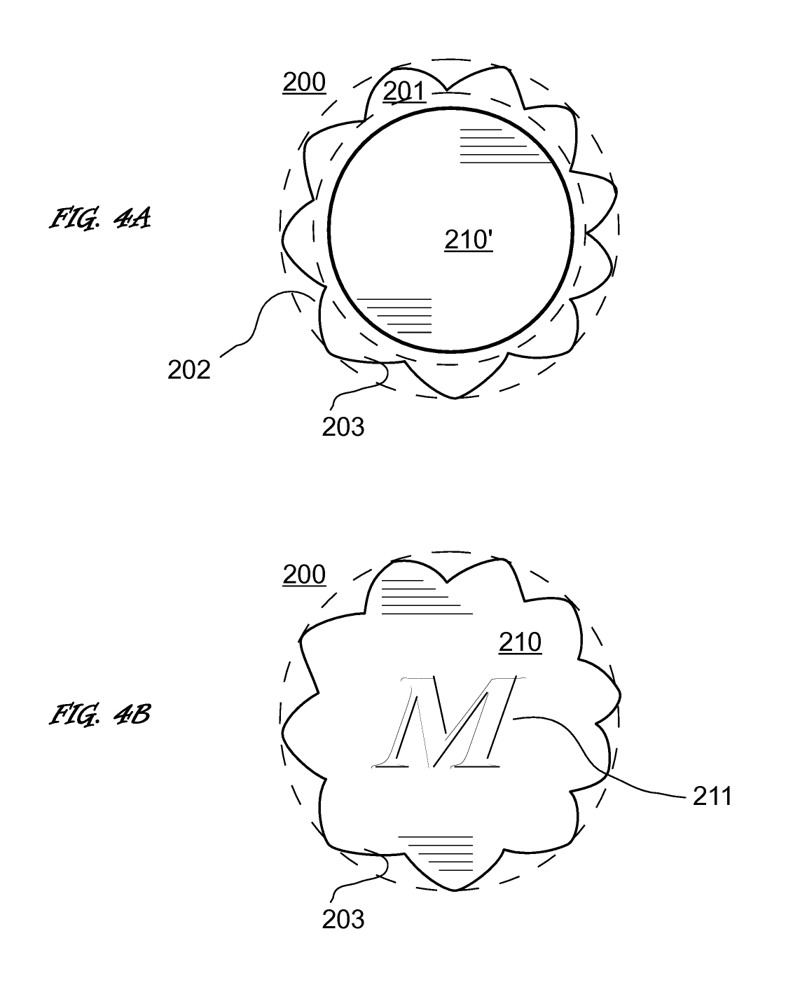

Several alternative processes for inserting the medallion 210′ in the handle 200 are shown in FIGS. 3A-C and 4A/B. As shown in FIGS. 3A, 3C and 4A, a medallion 210 is inserted into a cavity 202 for on the exterior upper surface of the handle, the process of adding the medallion 210′ to the handle 200 is preferably performed before the handle is attached to the cookware vessel 111. As shown in FIGS. 3A and 3C, the medallion is preferably first lined up with and freely inserted an at least a slightly larger cavity 201 from the upward surface of a handle 200. Then a forming die 300 impacts the medallion 210, by moving downward in the direction of arrow 310, forcing the medallion to compress and expand laterally to further fill the cavity 202. It is preferred that the medallion top surface is flush with or below the edge of the surrounding handle areas at the perimeter of the cavity 201.

Cavity 201 may have undercut sidewalls 202 to lock the expanded medallion 210 in place, as shown in FIG. 3B, after it expands. In the alternative embodiment shown in FIG. 3C, the forming die 300 has a raised pattern 301 on the face that impact the medallion 210. The raised portion embossed s an identifying pattern 211c in the medallion on impact

FIGS. 4A and 4B illustrate an alternative embodiment in which the perimeter wall 203 of the cavity 201 is irregular or at least non-circular having scalloped inward extensions 202. The expansion of the generally circular medallion in impact fills the portion of the cavity between these inward extensions, increasing the effective surface mechanical bonded over that with a round perimeter. It should be understood that neither the medallion nor the cavity are required to have a circular shape, which is optionally elliptically, but if having an straight sides, also preferably has rounded corners.

According, when such a completed handle 200 is added to the cookware vessel 110 shown in FIGS. 1A and 1B, a user or consumer will by grasping or inspecting the handle 200, readily observe the medallion 210, and be able to distinguish this cookware article from another cookware having a different construction, as for example lacking the copper or copper alloy ply 111, from one with a similar external appearance.

Further, the process of adding the medallion 200 as illustrated in FIG. 3C and 4A-B is a simple way of permanently displaying a trademark on the handle via the indented pattern 211c. However, the indented pattern can provide the user with other information, such as the vessel capacity, care instructions, induction stove compatibility and the like.

Generally, the bulk of the handle 200 is made from stainless steel and the medallion 200 is a more ductile metal, such as bronze, brass, copper and alloys thereof. However, it is also possible to embed a silver colored medallion 210′ made from a softer metal, such as aluminum into a brass handle or a plated metal handle made of for example stainless steel or another ferrous alloy.

In alternative embodiment of the invention the medallion could be round or coin-like, oval, square, annular or a star shape, as well as an annulus or ring or portion thereof.

Accordingly, as shown in FIG. 5A and 5B the cookware handle 5001 has one or rings 510 as the medallion, which extend around the grip portion 250 of handle 200, which is intermediate between its flange portion 251 and the end 252 that is distal from flange 251. Such rings 510 can be copper, brass, bronze and allows thereof, to provide visual contrast with the surrounding handle surface portions of the handle 200, which can silver colored metals, other metals or alloys, as well as plastic and may or may not include a softer or thermal insulating grip portion over the metal portion 250 using for grasping.

FIG. 6A-6C illustrates 2 alternative embodiments for attaching such a ring like metallic member 510. In FIG. 6A, the ring 510′ has a larger inner diameter than the end portion 252 of handle 200. However, as the handle cross-section expands gradually to shoulder 612 on the grip portion, inserting the ring 510′ with sufficient force (via die 610) causes its deformation, resulting in it being able to lock in the recess 614 around shoulder, such as it either being slightly, or with concurrent or subsequent radial compression, such as swaging. In FIGS. 6B and 6C, the ring is formed from is a wire segment 510″, that is wrapped at least partially into an annular cavity 613 or depression formed in a portion of the handle 200.

In FIG. 6B and 6C, an alternative forming die or winding tools can be used to wrap the wire length 510″ into the annular cavity 613 on the handle 200. Swaging can be subsequently deployed, depending on the desired shape of the final ring 510 and the cavity depth, if any.

Further, the embedded medallion can be purely decorative, and/or applied for the purpose of creating a prominent and easily identified trademark on the product, as well as identifying the core metal in a clad cookware article. As the medallion need not be a round shape, the shape can serve as such a mark as well as imprinted letters, signs, symbol or images thereon.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An article of cookware comprising:
a. a vessel having a bottom portion and substantially upright sides surrounding and connected to bottom portion, the uprights sides terminating at a rim,
b. at least one handle connected to the upright sides of the vessel, wherein said handle is formed of a first material to give a general external appearance, and has at least one medallion embedded in the a portion thereof to provide a contrasting appearance to the first material.

2. An article of cookware according to claim 1 wherein the first material is a metal having a silver appearance and the embedded medallion a metal selected from group consisting of brass, bronze, copper and alloys thereof to provides the contrasting appearance.

3. An article of cookware according to claim 1 wherein the medallion is an annular ring of embedded material.

4. An article of cookware according to claim 4 wherein the medallion is wrapped around an extending portion of the handle.

5. An article of cookware according to claim 1 wherein the medallion is generally planar and embedded in a generally planar portion of the handle.

6. An article of cookware according to claim 1 wherein the vessel has a clad construction being formed of multiple layers and the medallion has generally the same external appearance as one of the multiple layers.

7. An article of cookware according to claim 1 wherein the vessel has a clad construction being formed of multiple layers and the medallion has generally the same external appearance of a layer that is primarily covered by the other multiple layers.

8. A handle for an article of cookware: the handle comprising:
a. a flange portion for connection to an article of cookware,
b. a graspable portion connected to the flange portion,
c. wherein said handle is formed of a first material to give a general external appearance, and has at least one medallion embedded in one of the graspable and flange portion thereof to provide a contrasting appearance to the first material.

9. An article of cookware according to claim 8 wherein the first material is a metal having a silver appearance and the embedded medallion a metal selected from group consisting of brass, bronze, copper and alloys thereof to provides the contrasting appearance.

10. An article of cookware according to claim 8 wherein the medallion is an annular ring of embedded material.

11. An article of cookware according to claim 10 wherein the medallion is wrapped around an extending portion of the handle.

12. An article of cookware according to claim 8 wherein the medallion is generally planar and embedded in a generally planar portion of the handle.

13. A process for making a cookware handle, the process comprising the steps of:
a. providing a handle having a smooth body with a cavity,
b. providing a medallion,
c. inserting the medallion in the cavity,
d. impacting the medallion wherein the medallion compresses, expands and is locked into the cavity.

14. The process for making a cookware article according to claim 13 wherein the cavity has a non-circular edge.

15. The process for making a cookware article according to claim 13 wherein the cavity has scalloped edge.

16. The process for making a cookware article according to claim 13 wherein the cavity has a different shape than the medallion prior to said step of impacting.

17. The process for making a cookware article according to claim 13 wherein the medallion is a metal selected from group consisting of brass, bronze, copper and alloys.

18. The process for making a cookware article according to claim 13 wherein the medallion has a contrasting external appearance than an adjacent portion of the handle.
